(19) United States
(12) Patent Application Publication
(10) Pub. No.: US 2013/0111890 A1
(43) Pub. Date: May 9, 2013

(54) HYDRAULIC START/STOP SYSTEM

(71) Applicant: Marcus Rosth, Boras (SE)

(72) Inventor: Marcus Rosth, Boras (SE)

(73) Assignee: PARKER HANNIFIN AB, BORAS (SE)

(21) Appl. No.: 13/642,073

(22) PCT Filed: Apr. 19, 2010
(86) PCT No.: PCT/SE10/50421

§ 371 Date: Jan. 15, 2013

(51) Int. Cl. F15B 1/02

(52) U.S. Cl. CPC F15B 1/02
USPC 60/327; 60/414

(57) ABSTRACT

A start/stop arrangement in a fluid system comprising a controllable pump unit for supplying fluid pressure to at least one implement; a prime mover connected to a transmission device arranged to drive the pump unit; wherein the pump unit is installed on an outgoing power take off and is arranged to supply fluid pressure to the implement fluid system, that the pump unit is arranged accumulate fluid pressure in the accumulator. The fluid system further comprises a controllable motor unit connected to a fluid accumulator; that fluid pressure from the accumulator is arranged to drive the motor unit; and that the motor unit is connected to the prime mover by an overrun clutch, wherein the motor unit is arranged to supply torque to and start the prime mover when at least one predetermined condition is fulfilled. The invention further relates to a method for controlling the start/stop arrangement.

### TECHNICAL FIELD

The invention relates to a fluid system comprising a pump unit for supplying fluid pressure to at least one implement, where a prime mover arranged to supply a driving torque to the pump unit. The pump unit can be driven to accumulate fluid pressure in an accumulator which is used for driving a motor unit to start the prime mover or assist the prime mover during periods of high demand.

### BACKGROUND ART

Fluid systems for wheel loaders, forklift trucks, container handling machines and other machines or vehicles are equipped with a prime mover for driving a fluid pump for instance via a gearbox. In such a system, a prime mover in the form of an internal combustion engine is usually operated continuously to drive the fluid pump.

The prime mover is often connected to the pump or motor via a gearbox or a similar transmission arrangement, in order to achieve a desired rotational speed for driving a pump. The transmission and the prime mover have to be sized for peak demands from the driven implement. The pump may be a fixed or a variable displacement device, for supplying fluid pressure to at least one implement. If the pump is a fixed displacement device, the engine speed is controlled to supply a required pressure to the implement. If the pump is a variable displacement device, the pump displacement and/or the engine speed can be controlled to supply a required pressure to the implement.

During periods of low load on the implement or for machines with a stochastic working cycle, the engine may be operated at idling speed for extended periods of time. This may occur, for instance, during load holding and/or when a vehicle is being loaded or unloaded.

The invention aims to provide an improved hydraulic system for stopping the prime mover during periods of low load or idling and for starting the prime mover when a demand for fluid pressure is required by the system.

### DISCLOSURE OF INVENTION

The above problems have been solved by a method and an arrangement according to the appended claims.

According to a preferred embodiment, the invention relates to a fluid system comprising a pump unit, which may be a fixed or a variable displacement device, for supplying fluid pressure to at least one implement. The fluid system may be hydraulically or pneumatically operated and the at least one fluid implement can be any type of fluid operated device, such as a fluid cylinder or similar. A prime mover, in the form of a suitable internal combustion engine, is arranged to supply a driving torque directly or indirectly to the pump unit. The pump unit can be installed on an outgoing power take off (PTO) from the prime mover or otherwise be arranged to supply fluid pressure to the implement fluid system. The fluid system further comprises a controllable motor unit, which is preferably a fixed displacement device, connected to a fluid accumulator. In the subsequent text and the appended claims the term “pump unit” is defined as a device that may be used either as a pump or as a pump and a motor. Units of the latter type are sometimes termed “pump/motors”. In the case of a variable displacement device, the pump unit can be switched between these operating modes by setting a swash plate angle in a positive or a negative direction. At a positive angle the device operates as a pump, and at a negative angle the device operates as a motor. The prime mover is further arranged to directly or indirectly supply a driving torque to the pump unit. The pump unit is arranged to supply fluid pressure to the accumulator to accumulate fluid pressure during periods of low demand. A period of low demand is defined as a period in time when the load on the implement is below a first predetermined value. The load may be measured as a fluid pressure level required for operating the implement. During periods of low demand, the available torque from the prime mover exceeds the torque required by the pump unit to supply the fluid implement with sufficient fluid pressure. Fluid pressure can also be supplied when it is detected that the pressure in the accumulator is below a predetermined value, provided that the current load on the implement allows the accumulator to be charged. Fluid pressure from the accumulator is arranged to drive the motor unit to start the prime mover after a period of low demand during which the prime mover has been stopped. The prime mover, the pump unit and the motor unit may be connected by a common drive shaft.

According to the invention, the motor unit is connected to the prime mover by an overrun clutch, wherein the motor unit is arranged to supply torque to the prime mover when at least one predetermined condition is fulfilled.

A controllable two-way valve, such as a controllable solenoid valve, is arranged to connect the accumulator and the motor unit, acting as an on/off valve for the motor unit. The solenoid valve is also actuated to allow fluid flow from the pump unit to the accumulator during charging of the accumulator. A non-return valve is arranged to prevent flow from the accumulator towards the pump unit or the implement.

A proportional flow control valve is arranged to connect the motor unit to a source of low pressure, or drain. The proportional flow control valve controls the fluid flow from the accumulator through the motor and is used for controlling the speed and output torque of the motor. The flow control valve is provided with a check valve to prevent flow in the direction of the drain when the flow valve is in its non-actuated position. This prevents the motor from being operated during charging of the accumulator.

According to the invention, the overrun clutch is located between the motor unit and the prime mover. Alternatively, the overrun clutch is located between the motor unit and the pump unit. When it is detected that the prime mover is stopped and that an increased fluid pressure is required by the said implement, fluid pressure from the accumulator is arranged to drive the motor unit to supply torque to and start the prime mover. This is achieved by actuating the solenoid valve, to supply fluid pressure to the motor unit, and the flow control valve, to control the speed and torque of the motor unit.

The motor unit may be a separate unit or be installed in tandem, “piggy backed” onto the main implement pump unit, or be installed separately on one PTO if multiple PTO units are available. The pump displacement is preferably controlled by an electronic control system sensing the demand for power in the implement system. During periods of low energy demand the control system may increase the pump unit stroke in the positive direction to pump fluid into the accumulator and increase the stored pressure. The pressure in the accumulator can be monitored by means of a suitable pressure sensor, such as a pressure transducer. When a predetermined maximum pressure is sensed in the accumulator, the pump unit stroke is set to zero to allow the device to idle in order to conserve energy. If the pressure requirement from the load implement at this time is also zero, or remains zero for a predetermined time interval, the prime mover is stopped.

The pump unit and the above-mentioned valves are preferably electrically controlled. An electronic control unit may be provided for this purpose. The pump unit can be controlled by a load sensing device on the implement. As the demand for fluid power from the implement increases, the stroke of the pump unit is adjusted in a positive direction to increase the pressure of the supplied fluid. If this is determined to be insufficient, the power output of the prime mover is increased. During a period of peak load on the implement the pressure is supplied by the pump unit at maximum positive stroke, while being driven by the prime mover at maximum torque. The electronic control unit may store a number of maps used for controlling the stroke of the pump unit and the speed of the prime mover under predetermined operating conditions.

The prime mover may be connected to a suitable transmission device arranged to drive pump unit. One example of a suitable transmission is a hydro-dynamic gearbox. This type of transmission or gearbox has a maximum allowable limit for torque transmitted by the transmission. On a hydrodynamic gearbox the pump supplying the implement is mounted on a PTO drive connected to the gearbox primary drive side via a gear ratio which in most of cases is 1:1 with the prime mover. The allowed torque is determined by the construction of the gearbox and is in most cases limited to a lower torque than that available from the prime mover.

During periods of low activity the hydraulic system may be placed in an energy saving mode, whereby the engine is stopped. Examples of such periods may be when the electronic control unit detects that there has been no demand for hydraulic pressure from the implement or that the operator has not provided any input to the controls over a predetermined period of time. The energy saving mode may be initiated after a predetermined period of time, as described above, or in response to detected state corresponding to a number of pre-programmed conditions stored in the electronic control unit. One condition that must be fulfilled for initiation said mode is that the accumulator must be charged to, or over, a predetermined limit. This limit is determined in relation to the pressure required to allow the motor to supply a torque sufficient for enabling an engine start. Preferably the accumulator may be fully, or nearly fully, charged.

When the energy saving mode is initiated, an engine control unit will interrupt the fuel injection and/or the ignition of the prime mover. The engine control unit and the electronic control unit can be integrated in a single electronic control unit. The prime mover is then stopped and the hydraulic system is placed in stand-by. If the electronic control unit detects any activity requiring hydraulic pressure from the pump, such as a control input by the operator, the energy saving mode is interrupted. A control input can be that the operator actuates a vehicle control unit or an implement control unit, such as a lever or a joystick, for the implement. A further activity could be that it is detected that additional fluid pressure is required by the at least one implement, for instance to allow the implement to maintain a set position. Such a demand for pressure from the implement or a vehicle carrying the implement can be detected by a suitable sensor, such as a position, pressure or flow sensor, and transmitted to the electronic control unit. When an activity requiring hydraulic pressure from the pump is detected, the electronic control unit will immediately connect the accumulator to the motor unit. This will cause the pump unit to be driven, directly by the motor or indirectly by the prime mover being started, to supply hydraulic fluid to the hydraulic implement. In this way, the operator need not wait for the engine to start, as fluid pressure from the accumulator is immediately available for controlling and operating the at least one fluid implement. At the same time, the torque supplied by the motor will drive the gearbox and crank the prime mover. The engine control unit will resume the fuel injection and/or the ignition of the prime mover, which will then start and drive the system as normal. As soon as the engine is started, the torque transmission is interrupted, as the solenoid valve connecting the accumulator and the motor will close. Torque transmission in the direction of the motor is prevented by the overrun clutch. When normal operation is resumed, the pump will, if required, begin to charge the accumulator.

The invention further relates to a method for controlling a fluid system comprising a pump unit for supplying fluid pressure to at least one implement; a prime mover arranged to drive the pump unit; wherein the pump unit is installed on an outgoing power take off (PTO) for the implement fluid system, a controllable motor unit connected to a fluid accumulator, and at least one sensor for determining the state of the fluid system. The method comprises the steps of:
monitoring the current operating state of the prime mover, in order to determine if the prime mover is stopped or running;
monitoring the current load on the at least one implement, in order to determine a current pressure requirement for the said implement;
   and if it is determined that the prime mover is stopped;
controlling fluid pressure from the accumulator to drive the motor unit to supply a driving torque to start the prime mover when the current pressure requirement determined for the said implement exceeds the available pressure in the system; and
disconnecting the driving connection between the motor unit and the prime mover by means of an overrun clutch.

The method further involves controlling the prime mover to drive the pump unit in response to a pressure signal indicating the pressure in the accumulator. This is to ensure that the pressure in the accumulator is sufficient for performing a start of the prime mover. The prime mover can be controlled to drive the pump unit to charge the accumulator when the load on the implement is below a first predetermined value.

When it is determined that the prime mover is running, the fluid pressure from the accumulator is controlled to stop the motor unit.

The fluid system and method described above will make it possible to save energy by shutting down prime movers such as internal combustion engines during periods of low load. By using a fluid operated motor connected to the prime mover via an overrun clutch it is possible to downsize components, such as the motor used for starting the prime mover. Control of the motor is simplified, as it is only operated over short periods and can be controlled by a limited number of valves. The use of an overrun clutch ensures that there is no risk of overloading the motor when the prime mover starts, and the motor can be shut down independently of the operation of the overall fluid system.

### BRIEF DESCRIPTION OF DRAWINGS

The invention will be described in detail with reference to the attached figures. It is to be understood that the drawings are designed solely for the purpose of illustration and are not intended as a definition of the limits of the invention, for which reference should be made to the appended claims. It should be further understood that the drawings are not necessarily drawn to scale and that, unless otherwise indicated, they are merely intended to schematically illustrate the structures and procedures described herein.

FIG. 1 shows a schematic illustration of a hydraulic system according to a first embodiment of the invention;

FIG. 2 shows a schematic illustration of a hydraulic system according to a second embodiment of the invention;

### EMBODIMENTS OF THE INVENTION

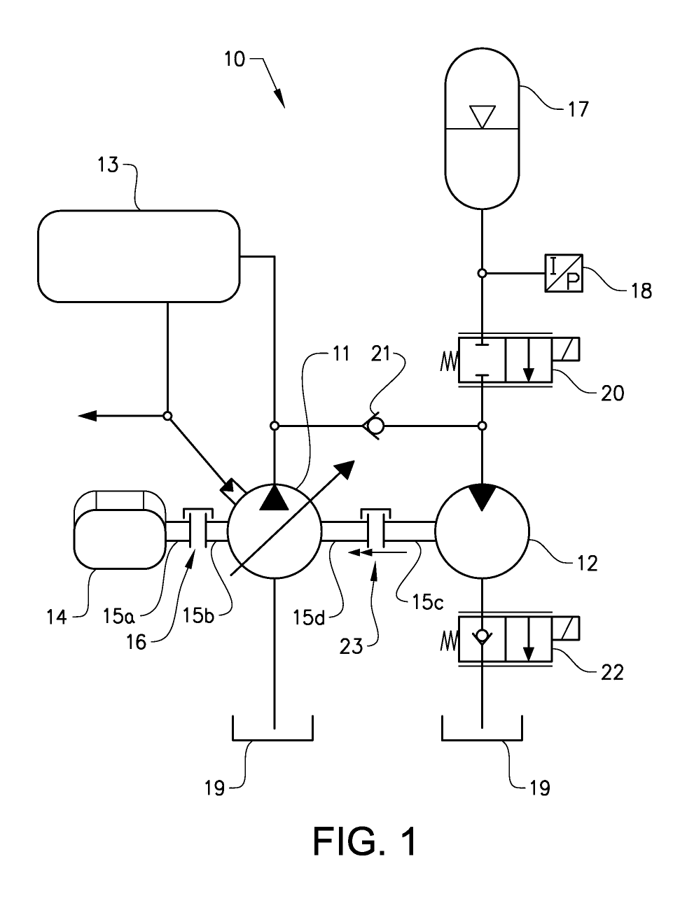

FIG. 1 shows a schematic illustration of a hydraulic system according to a first embodiment of the invention. The figure shows a hydraulic system 10 comprising a controllable pump unit in the form of a variable displacement pump 11 for supplying hydraulic pressure to a hydraulically driven implement (not shown), which implement is controlled by an operator by means of schematically indicated proportional valves 13. The controllable variable displacement pump unit will hereafter be referred to as the pump 11. A prime mover in the form of an internal combustion engine 14 is arranged to supply a driving torque to the pump 11. Torque is transmitted by an output shaft 15a from the engine 14 via a transmission 16 in the form of a hydrodynamic gearbox to a drive shaft 15b for the pump 11. The transmission 16 can comprise a controllable clutch. The hydraulic system 10 further comprises a controllable motor unit in the form of a fixed displacement motor 12 connected to a hydraulic accumulator 17. The controllable motor unit will hereafter be referred to as the motor 12. The motor 12 is arranged to supply a driving torque to the engine 14 in order to start the engine. Torque is transmitted by an output shaft 15c from the motor 12 via a one-way overrun clutch 23 to an input drive shaft 15d for the pump 11.

The load on the implement is measured as a hydraulic pressure level and an output signal from a pressure sensor (not shown) on the implement connected to the proportional valves 13 can be supplied as a hydraulic pilot pressure or an electric input signal to the pump 11 to control the angle of a swash plate in the pump 11. As schematically indicated in FIG. 1, the hydraulic pilot pressure or an electric input signal to the pump 11 can be received from additional proportional valves connected to further implements. A further pressure sensor 18 is provided between the motor 12 and the accumulator 17 to monitor the hydraulic pressure in the accumulator 17. A controllable two way valve 20 is provided between the motor 12 and the accumulator 17, to control to flow of fluid into or out of the accumulator 17.

The pump 11 is arranged to hydraulic pressure to and accumulate hydraulic pressure in the accumulator 17 during periods of low demand, when the load on the implement is below a first predetermined value, or when it is determined that the pressure in the accumulator 17 is below a predetermined value. Hydraulic fluid is supplied from and returned to a tank 19 connected to both the pump 11 and the motor 12. An electronic control unit ECU (not shown) is arranged to receive output signals from the pressure sensors and an engine speed sensor. Signals received and transmitted to and/or from the various components of the hydraulic system are not indicated in the figures. Depending on the current load on the implement connected to the proportional valves 13, the current pressure in the accumulator 17 and the engine speed, the electronic control unit ECU will output control signals to regulate the angle of the swash plates in the pump 11 and, if required, the speed of the engine 14.

During periods of low demand, the available torque from the engine 14 exceeds the torque required by the pump 11 to supply the hydraulic cylinder 13 with hydraulic pressure. The electronic control unit ECU will then control the engine 14 to operate at a predetermined constant speed for optimum fuel consumption. At this speed, the torque supplied from the engine 14 is sufficient to drive the pump 11 to charge the accumulator 17. When a predetermined pressure is achieved in the accumulator, a signal transmitted from the pressure sensor 18 will cause the electronic control unit ECU to adjust the angle of the swash plate in the motor 12 maintain this pressure. The accumulator 17 may of course be charged at any time if it is detected that the pressure is below a predetermined level.

A controllable two-way valve 21, such as a controllable solenoid valve, is arranged to connect the accumulator 17 and the motor 12, acting as an on/off valve for the motor. The two-way valve 21 is also actuated to allow fluid flow from the pump 11 to the accumulator 17 during charging of the accumulator. A non-return valve 20 is arranged to prevent flow from the motor 12 or the accumulator 17 towards the pump 11 or the implement.

A proportional flow control valve 22 is arranged to connect the motor 12 to the tank 19. The proportional flow control valve 22 controls the fluid flow from the accumulator through the motor 12 and is used for controlling the speed and output torque of the motor 12. The flow control valve 22 is provided with a check valve to prevent flow in the direction of the tank 19 when the flow valve 22 is in its non-actuated position. This prevents the motor 12 from being operated during charging of the accumulator 17.

During periods of low activity the hydraulic system may be placed in an energy saving mode, whereby the engine 14 is stopped. Examples of such periods may be when the electronic control unit detects that there has been no demand for hydraulic pressure from the implement or that the operator has not provided any control input over a predetermined period of time. The energy saving mode may be initiated after a predetermined period of time, or in response to detected state corresponding to a number of pre-programmed conditions stored in the electronic control unit. One condition is that the accumulator is charged to, or over, a predetermined minimum limit. This limit is determined in relation to the pressure required to allow the motor 12 to supply a torque sufficient for enabling the engine 14 to start. Preferably the accumulator can be fully, or nearly fully, charged. When the energy saving mode is initiated, an engine control unit will interrupt the fuel injection and/or the ignition of the engine 14.

If the electronic control unit ECU detects any activity requiring hydraulic pressure from the pump 11, such as a control input by the operator, the energy saving mode is interrupted. A control input can be that the operator actuates a vehicle control unit or an implement control unit, such as a lever or a joystick, for the implement. A further activity could be that it is detected that additional fluid pressure is required by the at least one implement, for instance to allow the implement to maintain a set position. Such a demand for pressure from the implement or a vehicle carrying the implement can be detected by a suitable sensor, such as a position, pressure or flow sensor, and transmitted to the electronic control unit.

When an activity requiring hydraulic pressure from the pump 11 is detected, the electronic control unit will immediately actuate the two-way valve 20 to connect the accumulator 17 to the motor 12. At the same time the proportional flow control valve 22 is actuated to control the fluid flow from the accumulator 17 through the motor 12 in order to control the speed and output torque of the motor 12. This will cause the pump 11 to be driven, directly by the motor 12 or indirectly by the engine 14 as it is being started, to supply hydraulic fluid to the hydraulic implement. In this way, the operator need not wait for the engine 14 to start, as fluid pressure from the accumulator 17 is immediately available to drive the pump 11 in order to control and operate the at least one fluid implement. At the same time, the torque supplied by the motor 12 will drive the pump 11 and the engine 14, via the gearbox 16, in order to crank the engine 14. The engine control unit will resume the fuel injection and the ignition for the engine 14, which will then start and drive the fluid system as normal. As soon as the engine 14 is started, the torque transmission from the motor 12 in the direction of the pump 11 and the engine 14 is interrupted, as the two-way valve 20 connecting the accumulator 17 and the motor 12 will close. Torque transmission in the direction of the motor 12 is prevented by an overrun clutch 23 located on a drive shaft between the pump 11 and the motor 12. When normal operation is resumed, the pump 11 will, if required, begin to charge the accumulator 17.

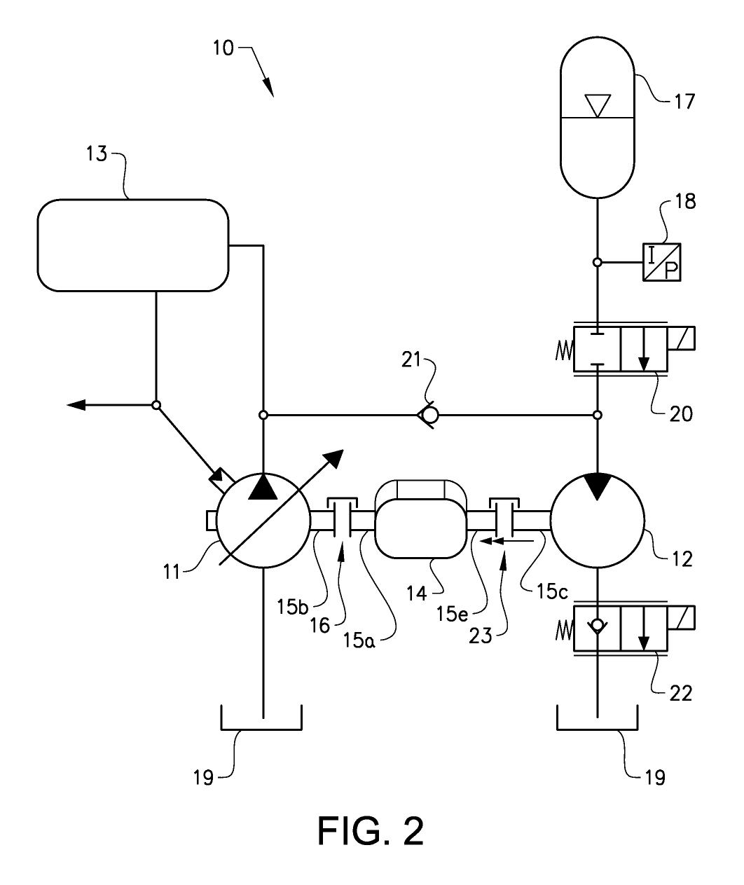

FIG. 2 shows a schematic illustration of a hydraulic system according to a second embodiment of the invention. As in FIG. 1, FIG. 2 shows a hydraulic system 10 comprising a controllable pump unit in the form of a variable displacement pump 11 for supplying hydraulic pressure to a hydraulically driven implement (not shown), which implement is controlled by an operator by means of schematically indicated proportional valves 13. The controllable variable displacement pump unit will hereafter be referred to as the pump 11. A prime mover in the form of an internal combustion engine 14 is arranged to supply a driving torque to the pump 11. Torque is transmitted by an output shaft 15a from the engine 14 via a transmission 16 in the form of a hydrodynamic gearbox to a drive shaft 15b for the pump 11. The transmission 16 comprises a controllable clutch. The hydraulic system 10 further comprises a controllable motor unit in the form of a fixed displacement motor 12 connected to a hydraulic accumulator 17. The controllable motor unit will hereafter be referred to as the motor 12. The motor 12 is arranged to supply a driving torque to the engine 14 in order to start the engine. Torque is transmitted by an output shaft 15c from the motor 12 via a one-way overrun clutch 23 to an input drive shaft 15e for the engine 14. The hydraulic system is controlled and operated in the same way as the system in FIG. 1.

Hence, the embodiment of FIG. 2 differs from the embodiment of FIG. 1 only in that is has different location of the pump 11 and its transmission 16. This arrangement allows the motor 12 to transfer torque to the engine 14 only, or to the engine 14 and the pump 11, during a start procedure for the engine 14. A clutch in the transmission 16 between the pump 11 and the motor 14 is used for selecting the desired torque transfer path.

The hydraulic system in FIG. 2 can be placed in an energy saving mode in the same way as the hydraulic system in FIG. 1 during periods of low activity. Detection and operation of the system for initiating and exiting the energy saving mode is identical in these embodiments and has been described in relation to FIG. 1 above.

The start-up procedure for the fluid system in FIG. 2 operates as follows. When an activity requiring hydraulic pressure from the pump 11 is detected, the electronic control unit will immediately actuate the two-way valve 20 to connect the accumulator 17 to the motor 12. At the same time the proportional flow control valve 22 is actuated to control the fluid flow from the accumulator 17 through the motor 12 in order to control the speed and output torque of the motor 12. The torque supplied by the motor 12 will drive the engine 14, via the overrun clutch 23, in order to crank the engine 14. In this example, the motor 12 is only used for cranking the engine 14, as the pump 11 is disconnected from the engine 14. The engine control unit will resume the fuel injection and the ignition for the engine 14, which will then start and drive the fluid system as normal. As soon as the engine 14 is started, the torque transmission from the motor 12 in the direction of the pump 11 and the engine 14 is interrupted, as the two-way valve 20 connecting the accumulator 17 and the motor 12 will close. Torque transmission in the direction of the motor 12 is prevented by an overrun clutch 23 located between the output shaft 15c from the motor 12 and the input drive shaft 15e for the engine 14. When normal operation is resumed, the pump 11 will, if required, begin to charge the accumulator 17.

Alternatively, the torque supplied by the motor 12 can drive the engine 14 and the pump 11. In this example, the motor 12 is used both for cranking the engine 14 and driving the pump 11, as the latter is connected to the engine. This will cause the pump 11 to be driven to supply hydraulic fluid to the hydraulic implement. In this way, the operator need not wait for the engine 14 to start, as fluid pressure from the accumulator 17 is immediately available to drive the pump 11 in order to control and operate the at least one fluid implement.

The invention is not limited to the above examples, but may be varied freely within the scope of the appended claims. For instance, the hydraulic systems shown in FIGS. 1 and 3 can also be placed in an energy saving mode during periods of low activity, as described in connection with FIG. 2 above.

1. A start/stop arrangement in a fluid system comprising a pump unit configured to supply fluid pressure to at least one implement; a prime mover connected to a transmission device arranged to drive the pump unit; wherein the pump unit is installed on an outgoing power take off and is arranged to supply fluid pressure to the implement fluid system, that the pump unit is arranged accumulate fluid pressure in an accumulator; wherein characterized in that the fluid system further comprises a controllable motor unit connected to a fluid accumulator; that fluid pressure from the accumulator is arranged to drive the motor unit; and that the motor unit is connected to the prime mover by an overrun clutch, wherein the motor unit is arranged to supply torque to and start the prime mover when at least one predetermined condition is fulfilled.

2. Fluid system according to claim 1, wherein the pump unit is a variable displacement device, provided with a controller for controlling the displacement of the pump in a positive and a negative direction.

3. Fluid system according to claim 1, wherein a controllable solenoid valve is arranged to connect the accumulator and the motor unit.

4. Fluid system according to claim 1, wherein a non-return valve is arranged to prevent flow from the accumulator to the pump unit.

5. Fluid system according to claim 1, wherein a proportional flow control valve is arranged to connect the motor unit to a source of low pressure.

6. Fluid system according to claim 1, wherein the overrun clutch is located between the motor unit and the prime mover.

7. Fluid system according to claim 1, wherein the overrun clutch is located between the motor unit and the pump unit.

8. Fluid system according to claim 1, wherein the fluid pressure from the accumulator is arranged to drive the motor unit to start the prime mover when a control unit is actuated by an operator.

9. Fluid system according to claim 1, wherein the fluid pressure from the accumulator is arranged to drive the motor unit to start the prime mover when a demand for pressure from the implement is detected.

10. Method for controlling a start/stop arrangement in a fluid system comprising a pump unit configured to supply fluid pressure to at least one implement; a prime mover arranged to drive the pump unit; wherein the pump unit is installed on an outgoing power take off (PTO) for the implement fluid system, a controllable motor unit connected to a fluid accumulator and arranged to be in driving connection with the prime mover, and at least one sensor for determining the state of the fluid system, wherein the method comprises:
monitoring the current operating state of the prime mover, in order to determine if the prime mover is stopped or running; and
monitoring the current load on the at least one implement, in order to determine a current pressure requirement for the said implement;
wherein, and if it is determined that the prime mover is stopped, the method further comprises;
controlling fluid pressure from the accumulator to drive the motor unit to supply a driving torque to start the prime mover when a demand for pressure is detected in the fluid system; and
disconnecting the driving connection between the motor unit and the prime mover by means of an overrun clutch.

11. Method according to claim 10, wherein the method comprises: controlling the prime mover to drive the pump unit in response to a pressure signal indicating the pressure in the accumulator.

12. Method according to claim 10, wherein
in that the method comprises controlling the prime mover to drive the pump unit to charge the accumulator when the load on the implement is below a first predetermined value.

13. Method according to of claim 10, comprising controlling fluid pressure from the accumulator to drive the motor unit to supply a driving torque to start the prime mover when a control unit is actuated by an operator.

14. Method according to claim 10, comprising controlling fluid pressure from the accumulator to drive the motor unit to supply a driving torque to start the prime mover when a demand for pressure from the implement is detected.

15. Method according to claim 10, wherein the method comprises controlling the fluid pressure from the accumulator to stop the motor unit when it is determined that the prime mover is running.
